(19) United States
(12) Patent Application Publication
(10) Pub. No.: US 2010/0289776 A1
(43) Pub. Date: Nov. 18, 2010

(54) SYSTEM, SOFTWARE MODULE AND METHODS FOR CREATING A RESPONSE TO INPUT BY AN ELECTRONIC PEN

(76) Inventors: Mattias Bryborn Krus, Lund (SE); Stefan Lynggaard, San Francisco, CA (US); Mattias Mårtesson, Malmo (SE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/668,195

(22) PCT Filed: Jul. 10, 2008
(86) PCT No.: PCT/SE08/50859

§ 371 Date: Jul. 2, 2010

Related U.S. Application Data
(60) Provisional application No. 60/929,908, filed on Jul. 17, 2007.
(60) Provisional application No. 60/977,569, filed on Oct. 4, 2007.

(30) Foreign Application Priority Data
Jul. 10, 2007 (SE) 0701675-1
Oct. 4, 2007 (SE) 0702229-6

(51) Int. Cl. G06F 3/033

(52) U.S. Cl. 345/179

(57) ABSTRACT

A system for creating a response to input by an electronic pen comprises: a processing unit, which records positions when the electronic pen is used for writing; and a software module, which is arranged to receive pen data created by the processing unit during writing and which is arranged to refine said pen data by identifying pen data representing occurrences of specific events and create event data representing such specific events occurring. The system further comprises an application for providing processing instructions to be performed in response to input by the electronic pen. The application is arranged to load an electronic file to said software module, wherein said electronic file comprises information regarding the printed document on which writing is made, and to provide set-up instructions to said software module, wherein the set-up instructions are application-specific and customizes the software module to the application.

### FIELD OF THE INVENTION

The present invention generally relates to handling input by an electronic pen, including refining pen data created by the electronic pen during writing and creating a response to the input.

### BACKGROUND ART

The Applicant of the present invention has developed a system for digitizing use of a pen and a writing surface. A writing surface, such as a paper, is provided with a position-coding pattern. An electronic pen is used for writing on the writing surface, while at the same time being able to record positions of the position-coded surface. The electronic pen detects the position-coding pattern by means of a sensor and calculates positions corresponding to written pen strokes. Such a position-coding pattern is described e.g. in U.S. Pat. No. 6,663,008.

The electronic pen enables a user to make input to a digital system in a fashion very similar to using ordinary pen and paper. The input made by means of the electronic pen may be used for e.g. entering information into a digital system or controlling an application running on a device of the digital system. Thus, the pen input need to be managed so that an appropriate action is performed by an application receiving the input made by means of the electronic pen.

In WO 2006/004505, an information management system for handling digital position data recorded by an electronic pen is disclosed. The electronic pen is provided with a position database, which provides templates for different segments of the position-coding pattern. The templates define the size, placement and function of any functional areas that may affect the operation of the pen. The templates may describe a layout of functional areas that is common for all pattern pages, that is a portion of the position-coding pattern corresponding to a single physical page, within the segment. However, the position database may also comprise page descriptions that define the size, placement and function of further functional areas within a specific pattern page.

The electronic pen further comprises a translator module, which is arranged to determine whether a detected position falls within a functional area by comparing the detected positions to the templates and page descriptions of the position database. In response to the translator module identifying that a detected position is within a functional area, the translator module is arranged to generate a corresponding event. Such events may then be used by an interpretation module within the electronic pen, which may operate an interpretation function on a pen stroke associated with the event.

The translator module of WO 2006/004505 creates events in the same way regardless of the detected position. This implies that the creation of events may not be adapted to an application that is to handle the pen input. Different information may be relevant to different applications. However, according to WO 2006/004505, information is outputted from the translator module in one way only.

In WO01/86405, another information management system for handling pen-based input is disclosed. The information management system comprises a handwriting capture interface which is connected to a central processing subsystem. The central processing subsystem is arranged to interpret and handle pen-based input captured through the handwriting capture interface. The central processing subsystem is further arranged to communicate with an external computing device running an application via an electronic message. The central processing subsystem may also be arranged to include application-specific information in the electronic message. Thus, the electronic message may differ depending on the application that is to receive the electronic message. However, the central processing subsystem does not provide the pen-based input to the application such that the application may interpret and independently determine actions in dependence of what input is made with the pen. Instead, functions of the application may be triggered by the application-specific information in the electronic message.

### SUMMARY OF THE INVENTION

It is an object of the present invention to handle input of an electronic pen in a flexible way. It is a further object of the present invention to facilitate controlling how pen input is to be handled.

Generally, the objects of the invention are at least partly achieved by means of methods, a computer-readable medium, a software module and a system according to the independent claims, preferred embodiments being defined by the dependent claims.

According to a first aspect of the invention, there is provided a system for creating a response to input by means of an electronic pen, said system comprising: a processing unit in an electronic pen, which processing unit is arranged to receive positional information, which positional information is recorded when the electronic pen is used for writing on a printed document, said processing unit being further arranged to convert the positional information to a sequence of detected positions of said electronic pen in relation to the printed document; a software module, which is arranged to receive pen data created by the processing unit during writing, said pen data including said sequence of detected positions, and which software module is arranged to refine said pen data by identifying pen data representing occurrences of specific events and create event data representing such specific events occurring; and an application for providing processing instructions to be performed in response to input by means of the electronic pen, said application being arranged to load an electronic file to said software module, wherein said electronic file comprises information regarding said printed document, and to provide set-up instructions to said software module comprising setting up how the software module is to refine pen data, wherein said set-up instructions are application-specific and customizes the software module to the application and wherein the software module is set up by the set-up instructions to compare the pen data to information of the electronic file for identifying occurrences of events; said application being further arranged to receive event data from said software module and to process instructions that are related to event data representing an occurrence of a specific event.

According to a second aspect of the invention, there is provided a method of creating a response to input by means of an electronic pen, wherein said electronic pen comprises a processing unit, which is arranged to receive positional information, which positional information is recorded when the electronic pen is used for writing on a printed document, said processing unit being further arranged to convert the positional information to a sequence of detected positions of said electronic pen in relation to the printed document, said method being performed by an application providing processing instructions to be performed in response to input by means of the electronic pen, and said method comprising: accessing a software module, which is arranged to receive pen data created by the processing unit during writing, said pen data including said sequence of detected positions, and which software module is arranged to refine said pen data by identifying pen data representing occurrences of specific events and create event data representing such specific events occurring; loading an electronic file to said software module, wherein said electronic file comprises information regarding said printed document; providing set-up instructions to said software module comprising setting up how the software module is to refine pen data, wherein said set-up instructions are application-specific and customizes the software module to the application and wherein the software module is set up by the set-up instructions to compare the pen data to information of the electronic file for identifying occurrences of events; receiving event data from said software module; and processing instructions that are related to event data representing an occurrence of a specific event.

According to a third aspect of the invention, there is provided a computer-readable medium having recorded thereon computer-executable instructions for implementing the method of the second aspect.

According to a fourth aspect of the invention, there is provided a method of refining input by means of an electronic pen, wherein said electronic pen comprises a processing unit, which is arranged to receive positional information, which positional information is recorded when the electronic pen is used for writing on a printed document, said processing unit being further arranged to convert the positional information to a sequence of detected positions of said electronic pen, and wherein said refining comprises identifying pen data representing occurrences of specific events and creating event data representing such specific events occurring, said method comprising: receiving pen data created by the processing unit during writing, said pen data including said sequence of detected positions; receiving an electronic file, wherein said electronic file comprises information regarding said printed document, said electronic file being received from an application providing processing instructions to be performed in response to input by means of the electronic pen; further receiving set-up instructions from the application, wherein said set-up instructions are application-specific; and setting up refining of pen data in accordance with said received set-up instructions, whereby the refining is arranged to include comparing the pen data to information of the received electronic file for identifying occurrences of events.

According to a fifth aspect of the invention, there is provided a computer-readable medium having recorded thereon computer-executable instructions for implementing the method of the fourth aspect.

According to a sixth aspect of the invention, there is provided a software module for refining input by means of an electronic pen, wherein said electronic pen comprises a processing unit, which is arranged to receive positional information, which positional information is recorded when the electronic pen is used for writing on a printed document, said processing unit being further arranged to convert the positional information to a sequence of detected positions of said electronic pen in relation to the printed document, said software module being arranged to receive pen data created by the processing unit during writing, said pen data including said sequence of detected positions, and said software module being arranged to refine said pen data by identifying pen data representing occurrences of specific events and create event data representing such specific events occurring; said software module being configurable for refining pen data in different manners specific to different applications providing processing instructions to be performed in response to input by means of the electronic pen and said software module further comprising an application programming interface for accessing refining functions of the software module, said refining functions comprising: allowing an electronic file to be loaded to said software module, wherein said electronic file comprises information regarding said printed document; and allowing setting up how the software module is to refine pen data, including setting up the software module to compare the pen data to information of the electronic file for identifying occurrences of events.

One advantage of these aspects is that the software module that is to refine pen data may be dynamically controlled. Thus, an application that is to process pen input may dynamically set up the software module, for example when the application is started. The application knows which electronic file that holds the electronic representation of the printed document, which is to be used for writing in order to give pen input to the application. Thanks to the arrangement of the software module, the electronic file may be loaded to the software module when the application is started and the software module may thus compare detected positions only to the loaded electronic file which describes the portion of the position-coding pattern that is currently of interest. Further, the software module may be designed such that the refining of pen data suits the application that is presently receiving data from the software module. This implies that only the data of interest need be provided from the software module.

Also, the software module may be first set up to provide refining of pen data according to the application-specific set-up instructions of a first application. When a second application is run, the same software module may now be set up to provide refining of pen data according to different application-specific set-up instructions of the second application. In this way, the software module may be customized to the application that is receiving data from the software module.

Still other objectives, features, aspects and advantages of the present invention will appear from the following detailed disclosure, from the attached dependent claims as well as from the drawings.

### BRIEF DESCRIPTION OF THE DRAWINGS

The embodiments of the invention will now be described in more detail with reference to the accompanying schematic drawings.

FIG. 1A illustrates how unique position-coded products are formed by merging different coding pattern and form layouts on different substrates.

FIG. 1B is a view of a system for information capture and processing using an electronic pen and the products in FIG. 1A.

FIG. 2A illustrates a part of an extensive position-coding pattern which is logically partitioned into pattern pages.

FIG. 2B is a conceptual view of a position-coding pattern which encodes pattern pages with identical coordinates.

FIG. 3 is a conceptual view to illustrate a correspondence between the electronic representation of a document and the corresponding printed document.

FIG. 4 illustrates storage sections in an AFD file.

FIG. 5 illustrates an embodiment of the AFD file.

FIG. 6 is a conceptual view to illustrate a convention for mapping a document layout to a pattern page.

FIG. 7 is a schematic view of a length-wise cross-section of an electronic pen.

FIG. 8 illustrates an Interaction Module for processing real-time pen data.

FIG. 9 is a flow chart of a method for processing real-time pen data.

FIG. 10 is a schematic view of transfer of information between an application, the Interaction Module and an electronic pen.

FIG. 11 illustrates the progress of a stream of events through the Interaction Module.

### DETAILED DESCRIPTION OF PREFERRED EMBODIMENTS

### 1. General

The invention will now be described in detail with reference to a system, wherein an electronic pen is arranged to record positional information when being used for writing on a printed document. The system may use a position-coding pattern for determining the position of the electronic pen. The position-coding pattern is a passive machine-readable pattern that can be applied to a product surface, such as paper, to encode position data thereon. The position data can then be retrieved from the encoded product surface by the use of an electronic pen, which may have an image sensor for imaging an optically readable position-coding pattern and a processor for analyzing the imaged pattern. By activating the image sensor while the pen is in contact with the product surface, sequences of position data (pen strokes) can be recorded to represent the pen's movement on the product surface. In this way, an electronic representation of handwriting can be generated.

The machine-readable pattern may be printed together with human-understandable graphics. If each product surface is printed with different pattern, resulting in different position data, it is possible to distinguish between position data originating from different product surfaces.

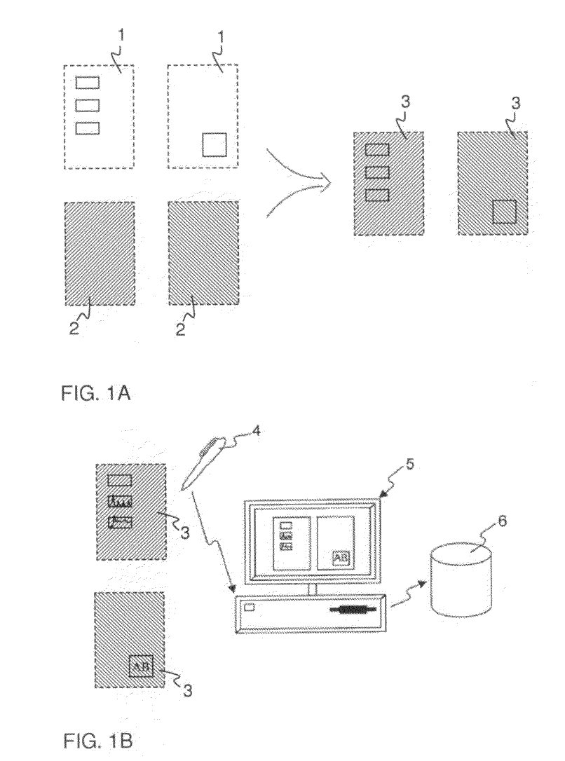

This principle can be used for information capture and processing. As shown in FIGS. 1A-1B, an electronically represented multi-page form 1 can be printed with unique pattern 2 on each page. When the printed form 3 then is filled in using an electronic pen 4, the resulting position data can be conveyed from the electronic pen 4 to a back-end processing system 5, in which the position data can be correlated to the individual pages of the originating form. The position data may for example be displayed to an operator and/or processed in accordance with processing rules for that specific form, and the resulting data may be stored in a database 6. Different printed copies of the same form may also bear different pattern, so that the position data uniquely identifies the originating form copy at the back-end system. Suitably, the electronic pen 4 has a unique penID, which is conveyed together with the position data, to allow the back-end system 5 to identify the originating pen, or at least differentiate the received data between different pens.

Clearly, this type of system requires a large position-coding pattern, since each page (and possibly each copy) needs to be provided with unique pattern.

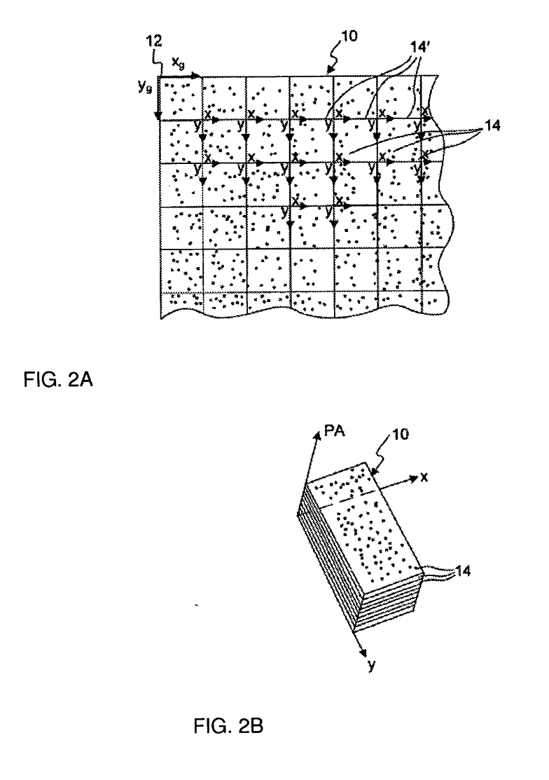

In one embodiment, shown in FIG. 2A, the position-coding pattern 10 is implemented to encode a large number of positions, in a global x,y coordinate system 12 (x_{g},y_{g}). Thus, the position-coding pattern 10 represents a huge continuous surface of positions. This huge pattern is then logically subdivided into addressable units 14, pattern pages, of a size suitable for a single physical page. Thus, each page is printed with pattern from a different pattern page 14, so that each printed page is encoded with unique positions in the global coordinate system 12. The subdivision of the position-coding pattern is known in the system, so that a page address (PA) for the relevant pattern page 14 can be derived from each recorded position. As shown in FIG. 2A, each pattern page 14 may be associated with a local coordinate system 14′, whereby a recorded position (in the global coordinate system 12) can be converted to a page address and local position (in the local coordinate system 14′) of the pattern page 14 identified by the page address.

Such a coding pattern and a subdivision thereof are disclosed in U.S. Pat. No. 6,663,008 and US2003/0061188.

In another embodiment, shown in FIG. 2B, the position-coding pattern 10 is divided into pattern pages 14 by way of its encoding. Specifically, the position-coding pattern 10 encodes a plurality of unique pattern pages 14, in which the encoded positions are identical between different pattern pages, but each pattern page is encoded with a unique identifier. Thus, the electronic pen records position data in the form of a unique identifier (a page address, PA) and x,y coordinates within a pattern page. Such coding patterns are known from U.S. Pat. No. 6,330,976, U.S. Pat. No. 5,661,506 and U.S. Pat. No. 6,766,944.

An electronic pen produces pen data when used for writing on a surface provided with the position-coding pattern 10. The pen data includes information of detected positions, the pen being lifted to finalize a stroke, the pen connecting to a remote apparatus, etc. The pen data may be refined in the pen or in a remote apparatus receiving pen data. The refining of pen data may be controlled by an application, which is arranged to handle pen input and provides processing instructions related to received pen data. The application is arranged to set up a software module for refining pen data such that the software module provides the pen data desired by the application. The application may specifically load an electronic file to the software module, wherein the electronic file comprises information regarding the printed document on which writing is entered using the electronic pen. The software module may thus use the electronic file in refining pen data, such that the pen data may e.g. be related to active areas on the document, which areas are associated with certain processing rules. In this way, the application may control the refining of pen data such that it receives only relevant information and information that is refined in a way that is suited to the needs of the application.

In this context, it should be understood that writing with an electronic pen is to be construed not only as drawing characters having a specific meaning, but also any kind of strokes or dots being drawn on the product surface with the electronic pen, such as drawing a picture, marking a box on the product surface, etc.

The electronic file may be any file that provides information of the printed document that may be used for interpreting pen data. Thus, the software module may use the electronic file for refining pen data. The electronic file may be an electronic document, providing an electronic representation of the printed document, which may include graphics defining the physical appearance of the printed document and information regarding functionalities to be associated with parts of the printed document. However, the electronic file need not be an entire electronic representation of the printed document, but may as an alternative only comprise specific information needed in order to refine pen data. Typically, such an electronic file may comprise information of areas in the printed document that are associated with a specific functionality, allowing the software module to relate pen data to such areas. However, the electronic file may only associate document or page identifiers that are unique for different pages of the printed document, allowing the software module to find a relevant identifier and associate pen data to the relevant identifier.

Below, it will be further described how an application may set up the software module to refine pen data. In order to give a complete understanding of this, the structure of a new type of electronic document will first be described in detail. Then, the details of an electronic pen will be described. Thereafter, the refining of pen data will be described.

### 2. Electronic Document

A physical copy of a document, which is provided with a position-coding pattern, may have a corresponding electronic representation. Such an electronic document comprises a number of document pages and may also comprise a separate representation of each physical copy of the document and its document pages. A specific document page of a specific physical copy of the electronic document is also referred to as a “page instance”. A page instance may comprise content which is common to all copies of the document page and content which is specific to the page instance. The content may typically be human-understandable graphics, which guides a user in what and where to write on a paper. The electronic document may also associate a respective pattern page with each such page instance. This pattern page may be unique for each page instance, which implies that a position in the position-coding pattern may be associated with a unique copy and page of the document.

The electronic document may further contain layout mapping data which defines the relative placement of the pattern page, or parts thereof, to the document page. The layout mapping data may include explicit location data for each instance of the document, with the location data defining where to place what part of a pattern page.

Further, the layout mapping data of the electronic document may define active areas within each document page that are to be associated with certain processing rules. Thus, if a pen stroke is recorded within such an active area, the pen stroke is to be handled in accordance with the associated processing rules. These processing rules may, for example, define that a pen stroke within an area is to be subject to handwriting recognition, whereby the information entered in the area may be processed in the back-end system. According to another example, an area may correspond to a check-box and marking of the check-box may initiate a function of the pen or the back-end system.

Active areas are not identifiable as such on the physical copy of a document (herein called “printed document”). Instead, the layout mapping data gives an electronic representation of the active areas for one or more document pages for use in subsequent processing of position data recorded from the printed document. However, the human-understandable graphics on the printed document may indicate the locations of active areas and how pen strokes within the active areas will be interpreted. This may be achieved by the human-understandable graphics containing boxes enclosing the active areas and text and/or illustrating pictures that explain the processing rules of the active areas.

In its simplest form, a document page may only consist of an area covering the entire page. Further, pen input within this area may only be handled for storing the inputted pen strokes as picture elements. The layout of active areas may be varied in an infinite number of ways, increasing the number of active areas and associating the active areas with other processing rules.

The layout mapping data defining the placement of the pattern page on the document page and the placement of the active areas within the document page is used for determining the positions of the position-coding pattern that are part of the active area. In this way, the positions of the active areas are defined. In the section captioned “Layout mapping” below, a way of accomplishing the layout mapping that requires a small amount of data will be further described.

The electronic document may typically be created by a system developer/deployer or a dedicated designer of page layouts. The designer designs the information that is to be presented to a user who writes on the printed document, i.e. the human-understandable graphics. The human-understandable graphics should guide the user in e.g. how to fill in a form. The designer further creates a layout of active areas in order to enable distinguishing between information entered in different parts of the document and allowing handling of the information in different ways. The layout of the human-understandable graphics may be designed by a first designer who is specialized in creating forms that are easy to use and understand, whereas the layout of active areas may be designed by a second designer who is specialized in programming and may associate appropriate functions with the active areas.

The designed document may then be printed and the printed document distributed to a dedicated user, whereas the layout of active areas may be incorporated in an electronic document that is transferred to a processing unit which is to receive pen input from writing on the printed document. The processing unit may be in the electronic pen or an apparatus receiving pen data.

In designing the electronic document, a special software program adapted to handling of electronic documents may be used. An example of such a special software program will hereinafter be referred to as “Document Module”. The Document Module is adapted to create an electronic document in proper file format and to manipulate data contained therein. The Document Module may be used in designing electronic documents, but also in reading and writing to an electronic document. Thus, the Document Module may both be used when an electronic document is to be designed and when data is to be read or written to the electronic document, such as for storing input by means of an electronic pen in the electronic document. Specifically, the Document Module provides an API (Application Programming Interface) for reading data in the electronic document and for deleting data in and adding data to the file. The Document Module API ensures that data is read/written in a consistent way at the correct place in the AFD file. The Document Module provides a software building block such that a system developer/deployer may use the API to integrate the module with customized software.

As will be described in further detail below, the electronic document may advantageously be represented by a file structure, wherein the layout of active areas associated with the document is separate from the definition of which pattern pages are included in the document and from the human-understandable graphics. This implies that the layout of active areas may be easily retrieved from the electronic document, which facilitates handling of the electronic document. Also, the layout of active areas may be associated with the respective document page, such that the specific layout of active areas within a document page may be easily retrieved. In particular, handling of pen input on a printed document will be facilitated, as further described below.

2.1. Exemplary File Structure

A common file format (AFD—Anoto Functionality Document) is advantageously used to convey data in a system handling input by means of an electronic pen. The AFD file format will now be described in detail.

In one embodiment, the data is organized in the AFD file by document page, and possibly by page instance. In an alternative embodiment, the data is organized in the AFD file by page address.

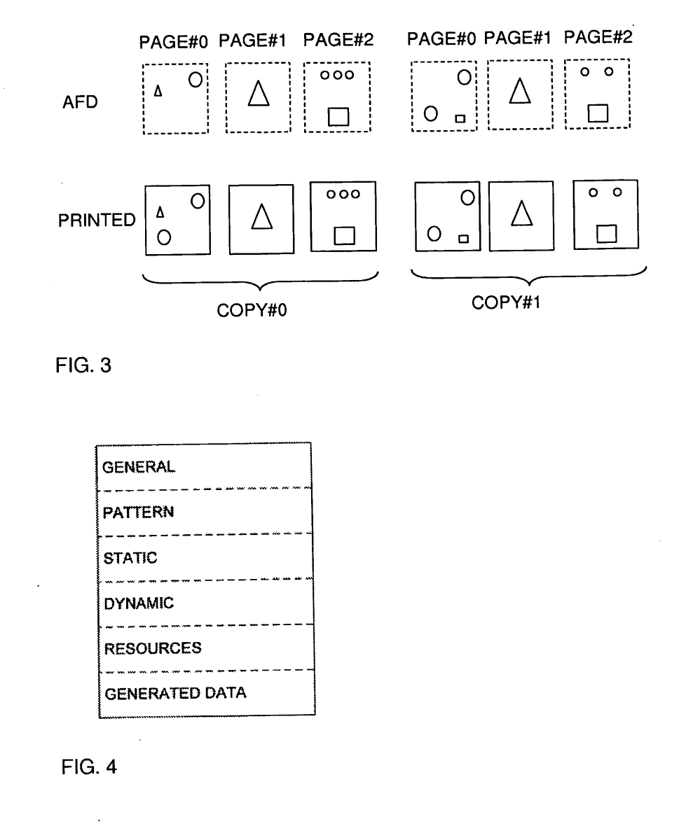

In either case, it is preferred that the Document Module API allows access to the AFD file using an index to individual instances of each document page. Suitably, this index references each instance by a combination of a copy number (copy#) and a page number (page#). Thereby, there is a perceived correspondence between the electronic representation of the document and its eventually printed counterpart, which is realized as a number of copies, each consisting of a number of pages, see FIG. 3. This analogy between the physical and digital worlds may be of great help to a system developer/deployer. If the data is organized by page address in the AFD file, it is thus preferable that the file contains conversion data relating page addresses to page instances (copy#, page#), and that the Document Module API includes a function to convert from instance (copy#, page#) to page address, and vice versa.

To facilitate access speed and readability, the AFD file may also be structured into mandatory storage sections, each being dedicated for a specific category of data. Within these storage sections, data may be structured by (copy#, page#) and/or page address, as applicable.

The AFD format is suitably designed to allow system developers/deployers to add customized storage sections, which will be ignored by the above Document Module API but can be accessed through a file reader of choice. This will allow system developers/deployers to associate any type of data with a document through its AFD file. For this purpose, it is clearly desirable for the AFD file to be accessible via standard file readers and/or text editors.

In one embodiment, the AFD file is written in a descriptive markup language such as XML and tagged to identify different storage sections.

In another embodiment, the AFD file is implemented as an archive file which aggregates many files into one, suitably after compressing each file. This allows different types of files to be stored in their original format within the AFD file, and provides for a small file size of the AFD file. The different storage sections in the AFD file may be given by folders and/or files within the archive file. In one specific embodiment, the archive file is a ZIP file.

In one embodiment, shown in FIG. 4, the AFD file includes six mandatory categories of data, which may or may not be given as explicit storage sections in the AFD file: GENERAL, PATTERN, STATIC, DYNAMIC, RESOURCES and GENERATED DATA. GENERAL includes metadata about the document, including mapping data indicating the mapping between pattern pages and page instances. PATTERN includes one or more pattern licenses that each defines a set of pattern pages. STATIC includes page specifications (page templates) that define an invariant layout for each document page, i.e. layout data which is relevant to all instances (copies) of a document page. Such layout data may include graphical elements, active areas, and properties associated with such active areas. Graphical elements include human-understandable elements (lines, icons, text, images, etc) as well as pattern areas, i.e. subsets of the actual coding pattern. DYNAMIC includes page specifications that define instance-specific layout data, i.e. layout data which is unique to a particular instance (copy) of a document page. Such layout data may also include graphical elements, active areas, and properties associated with such active areas. RESOURCES includes resources that are either common to the document or that are referenced by the static or dynamic page specifications. GENERATED DATA includes data which is generated in connection with the physical document (the coded product as printed), such as pen strokes, pictures, sound, etc.

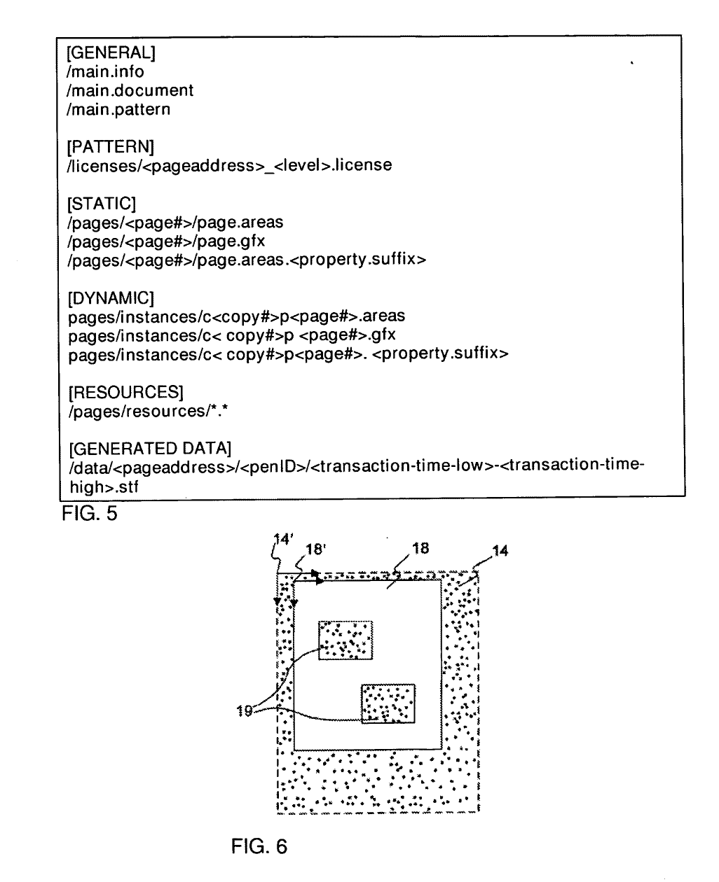

An embodiment of the AFD format, implemented as an archive file, is schematically depicted in FIG. 5, in which different data storage sections are indicated within brackets for ease of understanding.

The GENERAL section includes three XML files in the top folder of the AFD file: main.info, main.document and main.pattern. The .info file contains global data (metadata) about the AFD file, which may be selectively extracted from the AFD file for simplified processing on the platform, e.g. for locating a proper AFD file among a plurality of AFD files, for routing the AFD file to a proper destination, etc. The .document file includes document data (metadata) which is used when accessing data in other data storage sections of the AFD file, typically in reading, writing or mapping operations. The .pattern file includes basic page mapping data. It is thus realized that the .pattern file is updated whenever pattern licenses are added to the AFD file.

The PATTERN section includes a licenses folder for holding one or more pattern license files. Each .license file is identified by its starting page address.

The STATIC section, which holds static page specifications, includes a pages folder which has a subfolder for each page of the document, given by page number (page#). Each such subfolder can hold an area collection, given by a page .areas file, a graphics collection, given by a page .gfx file, and one or more property collections. Different file extensions (suffix) are used to distinguish different property collections from each other. The area collection defines active areas (given by areaIDs), i.e. areas to be used by the processing application. The graphics collection defines or identifies graphical elements that collectively form the visible layout of the page.

Each property collection is used to associate a specific property to the active areas defined by the .areas file. Specifically, the property collection associates a set of areaIDs with data strings. A property collection could be used to associate the active areas on a page with area names, character-recognition types (number, character, email, phone number, etc), audio file names, function calls, pen feedback vibration types (one thump, double thump, etc).

The DYNAMIC section, which holds dynamic page specifications, is organized similarly to the STATIC section and stores corresponding data. Specifically, this section includes an instances subfolder to the pages folder, which can hold an area collection, a graphics collection and one or more property collections for each instance. Each such collection is given a file name that identifies the relevant instance, given by copy number (copy#) and page number (page#).

The RESOURCES section includes a resources subfolder to the pages folder. The resources subfolder can hold any type of file which is either common to the document or is referenced in the static or dynamic page specifications. Such resources may include background images of different resolution to be used when displaying recorded position data, audio files, image files depicting a respective graphical element, an originating document file such as a word-processing document, a PDF file, a presentation document, a spreadsheet document, etc.

The GENERATED DATA section includes a data folder, which holds all data generated in connection with the document as printed. Recorded position data is stored as time-stamped pen strokes. In the illustrated example, the pen strokes are stored in a proprietary .stf file format, and with a file name that indicates the time range for the included pen strokes, i.e. the earliest and latest time stamps in the file. This name convention is used to facilitate temporal mapping, i.e. to make it easy to quickly find pen strokes based on their recording time.

The pen strokes are stored in a structure of subfolders, preferably sorted by page address and penID. The page address thus identifies the pattern page from which the pen strokes were recorded, and the penID identifies the electronic pen that recorded the pen strokes. In contrast to other parts of the AFD file, pen strokes are preferably associated with their originating page address instead of instance (copy#, page#). The page address is unique within the entire system, whereas the instance is only unique within a particular AFD file. If pen strokes are associated with page address they can easily be transferred between different AFD files. Furthermore, it might be desirable for electronic pens to use the AFD format as a container of pen strokes. Generally, the electronic pen has no information about the page mapping for a particular document, and is thus unable to store the pen strokes based on instance.

Other generated data may also be stored in the data folder, or in an appropriate subfolder, preferably with a file name that identifies the time range, and suitably with a file extension that identifies the type of data. Such generated data may include a picture taken by the pen or by an accessory device in connection with the printed document, an audio file recorded in connection with the printed document, bar code data recorded in connection with the printed document, text resulting from handwriting recognition (HWR) processing of pen strokes, etc.

Using a file name that is based on a time stamp, page address and penID, files that were created in connection to each other will be linked. For example, pen strokes, a photo and a GPS position recorded simultaneously will be stored with identical file name and only differing file extensions. This implies that these linked files may easily be retrieved together.

2.2. Layout Mapping

The AFD file also contains layout mapping data which defines the relative placement of the pattern page, or parts thereof, to the document page. The layout mapping data may include explicit location data for each instance of the document, with the location data defining where to place what part of a pattern page.

However, to simplify processing and reduce the AFD file size, the layout mapping data is preferably partly based on mapping by convention. As explained above (see FIGS. 2A-2B), every pattern page 14 may be associated with a local coordinate system 14′ (“pattern page coordinate system”) with a known origin on the pattern page, e.g. its upper left corner. As shown in FIG. 6, every document page 18 may likewise be associated with a local coordinate system 18′ (“paper coordinate system”) with a known origin on the document page, e.g. its upper left corner. In one embodiment of FIG. 6, there is, by convention, a known and fixed relation between these coordinate systems 14′, 18′ such that the pattern page 14 completely overlaps the associated document page 18. In the example of FIG. 6, the origin of the paper coordinate system 18′ can be expressed as a pair of non-negative x,y coordinates in the pattern page coordinate system 14′. Using this convention, the document page 18 is thus conceptually superimposed on the pattern page 14 in a known way. By further convention, a selected subset of the pattern page (pattern area 19) is placed on the document page 18 in its overlapping location. Thus, by specifying a pattern area 19 (in the pattern page coordinate system 14′), its location on the document page 18 (in the paper coordinate system 18′) is automatically given. Vice versa, the pattern area 19 is automatically known for any region specified on a document page 18 (in the paper coordinate system 18′). Conceptually, this can be compared to a “Christmas calendar”, in which hinged doors in a cover sheet can be opened to reveal a hidden underlying sheet. When a region is defined on the document page 18, the underlying pattern (pattern area 19) is revealed.

Clearly, only a small amount of data is required to specify pattern areas 19 on document pages 18, resulting in a reduced size of the AFD file. For example, it is sufficient to define the location of a region on the document page; its content of pattern is known by convention.

In one embodiment, the system developer/deployer is only exposed to one of the paper coordinate system 18′ and the pattern page coordinate system 14′. Thus, the location and size of active areas and graphical elements are all defined in one of these coordinate systems. Likewise, electronic pens will output position data given in this coordinate system. In the currently preferred embodiment, the developer/deployer is exposed to the paper coordinate system 18′, again in order to enhance the analogy between the physical and digital worlds. The location of a graphical element as given in the AFD file, will thus match the location of the graphical element on the printed product. In this preferred embodiment, the electronic pen needs to convert positions in the pattern page coordinate system 14′ to positions in the paper coordinate system 18′, which is done by a simple linear coordinate shift.

### 3. Electronic Pen

The electronic pen has a capability to detect its position on a product surface as the pen is used for writing on the product surface. The electronic pen may be arranged to record positional information in a number of different ways. For example, the electronic pen may comprise a camera and be arranged to record images of an optically readable position-coding pattern on the product surface. Alternatively, the position-coding pattern may be applied as an electrical, chemical, or some other type of pattern, which is detected by appropriate means instead of the images of the optically readable pattern. The pen may e.g. have a conductivity sensor that detects an electrical pattern.

The electronic pen further comprises a processing unit which is able to convert positional information recorded by the electronic pen during writing to a sequence of detected positions. The processing unit receives positional information from a sensor that detects a position-coding pattern on the product surface. The processing unit may comprise software for decoding a detected pattern to positions, wherein the software holds information of the structure of the position-coding pattern and is thus able to determine a position from a detected part of the pattern.

The electronic pen may be arranged to transfer the sequence of detected positions to a separate device, which may be able to further interpret the detected positions. Implemented in this way, the electronic pen may be very simple and only be able to output a stream of positions. The electronic pen may be arranged to be connected to the separate device by means of a wireless or wired connection. To this end, the electronic pen need not even comprise a storage memory, but all detected positions may be directly transferred to the separate device.

However, the electronic pen may also comprise further functionalities. For example, the electronic pen may comprise a memory for storing detected positions which may be transferred at request to a separate device. The electronic pen may also comprise units for providing feedback to a user, such as a display, a speaker, etc. The electronic pen may also comprise further sensors for detecting more information that may be associated with the detected positions. To this end, the electronic pen may comprise a camera, separate to the camera for detecting the optically readable position-coding pattern, for obtaining pictures, a microphone for recording sounds, a force sensor for detecting the pressure applied by the pen on the product surface, etc.

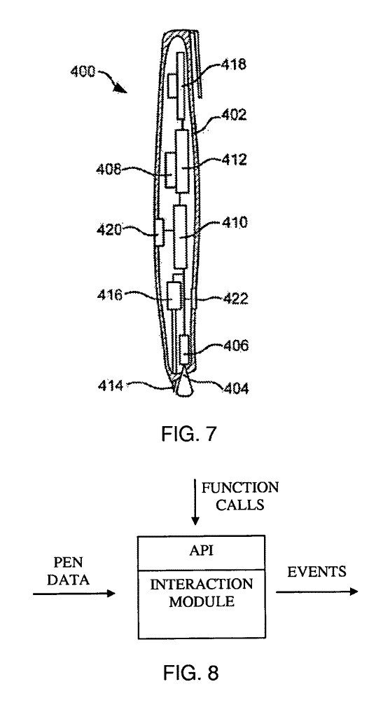

Below follows a detailed description with reference to FIG. 7 of an embodiment of an electronic pen 400 that can be used in a system of the above-described type. The pen has a pen-shaped casing or shell 402 that defines a window or opening 404, through which images are recorded. The casing contains a camera system 406, an electronics system and a power supply.

The camera system 406 comprises at least one illuminating light source, a lens arrangement and an optical image reader (not shown in the drawing). The light source, suitably a light-emitting diode (LED) or laser diode, illuminates a part of the area on the product surface that can be viewed through the window 404, by means of infrared radiation. An image of the viewed area is projected on the image reader by means of the lens arrangement. The image reader may be a two-dimensional CCD or CMOS detector which is triggered to capture images at a fixed or variable rate, typically at about 70-100 Hz.

The power supply of the pen 400 is advantageously at least one battery 408, which alternatively can be replaced by or supplemented by mains power (not shown).

The electronics system comprises a processing unit 410 which is connected to a memory block 412. The processing unit 410 is responsible for the different functions in the electronic pen and will therefore hereinafter be called a control unit 410. The control unit 410 can advantageously be implemented by a commercially available microprocessor such as a CPU (“Central Processing Unit”), by a DSP (“Digital Signal Processor”) or by some other programmable logical device, such as an FPGA (“Field Programmable Gate Array”) or alternatively an ASIC (“Application-Specific Integrated Circuit”), discrete analog and digital components, or some combination of the above. The memory block 412 preferably comprises different types of memory, such as a working memory (e.g. a RAM) and a program code and persistent storage memory (a non-volatile memory, e.g. flash memory). Associated software is stored in the memory block 412 and is executed by the control unit 410 in order to provide a pen control system for the operation of the electronic pen. One embodiment of a pen control system for this kind of electronic pen is described in WO 2006/049573, which is hereby incorporated by reference. One function provided by the control unit 410 is a clock, allowing relative and optionally absolute time to be retrieved by software executing in the control unit 410. The clock can be implemented in the control unit 410 itself or using an external unit (not shown).

The casing 402 also carries a pen point 414 which allows the user to write or draw physically on the product surface by a pigment-based marking ink being deposited thereon. The marking ink in the pen point 414 is suitably transparent to the illuminating radiation in order to avoid interference with the opto-electronic detection in the electronic pen. A contact sensor 416 is operatively connected to the pen point 414 to detect when the pen is applied to (pen down) and/or lifted from (pen up) the product surface, and optionally to allow for determination of the applied pressure. Based on the output of the contact sensor 416, the camera system 406 is controlled to capture one or more images between a pen down and a pen up. These images are processed by the control unit 410 to decode the positions that are represented by the position-coding pattern on the imaged areas of the product surface. Thus, the control unit 410 generates position data, defining a sequence of positions that represent the absolute or relative locations and movements of the pen on the surface.

The generated position data can be output by the pen, via a built-in transceiver 418 functioning as a communications interface, to a nearby or remote apparatus. To this end, the trans-ceiver 418 may provide components for wired or wireless short-range communication (e.g. Bluetooth, USB, RS232 serial, radio transmission, infrared transmission, ultrasound transmission, inductive coupling, etc), and/or components for wired or wireless remote communication, typically via a computer, telephone or satellite communications network, for example utilizing TCP/IP.

The control unit 410 may register significant changes occurring in the pen. When registering a significant change, the control unit 410 creates pen data describing the change. A significant change occurs when a unit in the pen that collects information regarding the relation between the pen and its exterior registers a change. The control unit 410 may thus e.g. create pen data corresponding to the contact sensor 416 detecting a pen down or a pen up, the transceiver 418 connecting to or disconnecting from an apparatus through the communications interface. The control unit 410 may also create pen data for each new position being decoded. Further, if the decoding for some reason is not successful, pen data indicating an error may be created.

The pen data created by the control unit 410 may be used for controlling actions to be taken by the pen or an apparatus receiving input from the pen. The pen data enable real-time response to the significant changes occurring in the pen. The handling of pen data for determining that an action is to be taken will be described in detail below.

The pen may also include an MMI (Man Machine Interface) 420 which is selectively activated for user feedback. The MMI may include a display, an indicator lamp, a vibrator, a speaker, etc.

Still further, the pen may include one or more buttons 422 by means of which it can be activated and/or controlled.

The pen may also include hardware and/or software for generating free-standing data, e.g. audio data, image data, video data, barcode data, and/or character-coded data. The pen may for instance include a microphone for recording audio data, an optical sensor and software for recording and processing of barcode data and/or handwriting recognition (HWR) software for converting position data representing handwriting to character-coded data.

The memory block 412 of the pen may store pen-resident parameters, e.g. a penID, which uniquely identifies the pen, a language identifier, a name, a street address, an electronic mail address, a phone number, a pager number, a fax number, a credit card number, etc. The pen-resident parameters may be stored in the pen in connection with the manufacturing of the pen and/or down-loaded in the memory block during use of the pen.

### 4. Event Handling

As described above, the control unit 410 of the electronic pen creates pen data describing significant changes in the pen. This pen data provides basic information of how the electronic pen is used. The pen data may further be used in order to create more specific real-time information of how the electronic pen is used. In other words, the pen data may be refined in order to comprise information of specific interest. To this end, the pen data may be examined for identifying pen data that satisfies certain requirements and thereby indicates that an event specified by the requirements has occurred. When such pen data is identified, a data record may be created specifying the occurrence of the event. Hereinafter, the term “event” will also be used for referring to a single data record specifying the occurrence of an event. Data records that have not been refined and thus describe significant changes in the pen are called “basic events”.

The refining of pen data may be performed by a software module that is specifically adapted for handling pen data. The software module may be run on the control unit 410 of the pen or on an apparatus receiving pen data. The software module may be arranged to provide algorithms for identifying pen data describing occurrences meeting specific requirements. Function calls may be made to the software module for activating algorithms. In this way, the refining of pen data performed by the software module may be controlled by function calls. This implies that an application, e.g. a software program for handling pen input, may set up in a manner specific to the application how the software module is to refine pen data in order to provide event data in a manner desired by the application, as illustrated in FIG. 8. For example, the function calls allow an electronic file to be loaded to the software module. Then, the software module may use the information of the electronic file in order to refine pen data. The pen data may be compared to the electronic file so that the software module may identify how e.g. detected positions relate to a document page. When an electronic file has been loaded, the software module may be set up to e.g. identify if a detected position is within an active area. Thus, the software module may put the detected position into context for interpreting the pen input made by a user.

The electronic file may be loaded to the software module by e.g. providing a pointer to the electronic file, such that the software module may access the electronic file in a memory. The electronic file may alternatively be stored in a local memory accessible to the software module. The software module will only need access to the electronic file as long as it is providing refined pen data as set up by an application. Thus, when the application is stopped, the software module may release a pointer to the electronic file, which will free memory when the electronic file has been stored in the local memory accessible to the software module.

The event data may be used to trigger responses to pen input. An application that receives event data may associate processing instructions with types of events. Thus, if an event is received by the application, the application may take appropriate action. For example, if an event indicating that a pen stroke has been input in an active area is received, the application may execute operations associated with the active area, such as displaying a picture, playing an audio file, storing strokes to a file, loading a file to the electronic pen, etc.

The event data may be provided as a stream of data records. Alternatively, the event data may be provided as separate data packages. Each event may hold information of e.g. a time of recording the data, a penID, and information specific to the event, such as a page address and/or position in the position-coding pattern, an areaID of an active area, etc.

4.1. Application Control of Event Handling

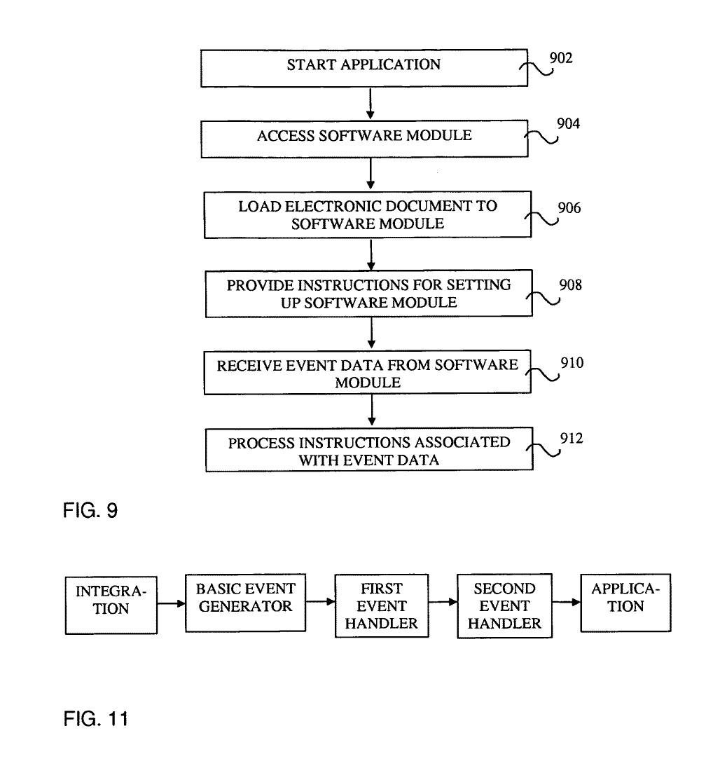

As indicated above, the refining of pen data by the software module may be controlled through function calls to the software module. Thus, as illustrated in FIG. 9, an application for handling pen input may control the function of the software module. When such an application is started, step 902, it may call the software module, step 904, to set up the refining of pen data. This may include loading an electronic document to the software module, step 906, and providing instructions, step 908, through the function calls for setting up the function of the software module. Then, the application may listen to event data from the software module, step 910, which event data may hold merely the information relevant to the application. The application may further process instructions associated with specific event data, step 912.

A software developer/deployer may create the application and adapt the application to use the function calls of the software module such that the application, when being run, will set up the software module to refine pen data in a desired manner. The system developer/deployer may associate one or more relevant electronic files with the application when creating the application. The application may then set up the software module using the electronic file(s) containing relevant information for refining pen data in a manner desired by the application.

The software module may be arranged to run on an apparatus, such as a personal computer, a mobile phone or a Personal Digital Assistant, receiving pen data from an electronic pen. The application may also be run on the apparatus that is arranged to receive pen data, whereby the application may easily access the software module in order to set up the refining of pen data. Alternatively, the application may be run on a further apparatus and still be used to control the software module running on an apparatus receiving pen data. The refined pen data may then be transmitted from the software module to the application running on the further apparatus.

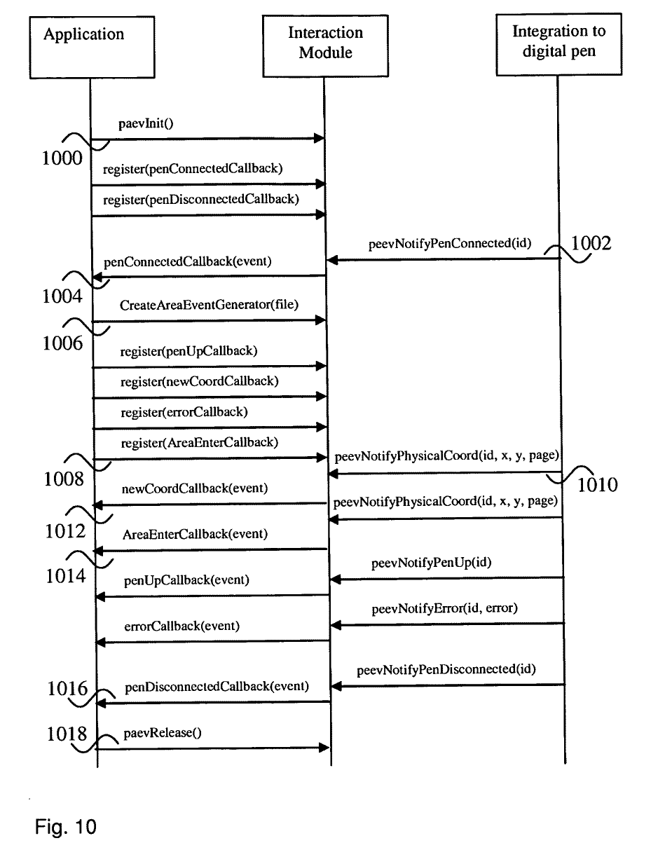

Referring now to FIG. 10, the transfer of information between the application, the software module and the pen will be described. Thus, when the application is started, the application sends an initiation command 1000 to the software module. The application further sends a request to receive information regarding a pen being connected or disconnected to the apparatus that is arranged to receive pen data. The application registers with the software module such that when the software module receives pen data 1002 indicating a pen being connected, the pen data will be forwarded to the application 1004. Thus, the application now knows that an electronic pen is connected to the software module and that the software module will start to receive pen data from the electronic pen. The application will thus set up the software module so that the pen data will be refined in a desired manner. In this regard, the application sends application-specific function calls 1006 to the software module for setting up the refining of pen data and customizing it to the application. As exemplified, the application may request the software module to generate events representing a stroke entering an active area of the printed document. To this end, the application may use a function call of the software module for making the software module compare received pen data representing detected positions to a layout of active areas of an electronic file. The application also informs the software module of what type of events 1008 that the application wants to receive, such that the software module will transfer such events to the application. The software module will now use the requested algorithms in processing of the received pen data. Thus, when the software module receives a new coordinate 1010 from the pen, the software module will examine whether it is within a new active area as specified by the electronic file. If not, the software module may send an event representing the new coordinate 1012 to the application without adding any information of the detected position. If the software module finds that the new coordinate is within an active area, the software module creates an event representing that a stroke has entered the active area and sends this event 1014 to the application. The software module may now continue to send events to the application as long as further pen data is received. When the electronic pen is disconnected, the software module registers the disconnection and forwards data 1016 regarding pen disconnection to the application. The application may thereafter release 1018 its connection to the software module, before the application is stopped.

The application may be started by a user that operates the apparatus on which the application is to be run. However, there may be a master application running on the apparatus, which master application initially sets up the software module in order to receive information on new coordinates from the software module. The master application may associate applications with different events from the software module, such as a new coordinate within a specific range in the position-coding pattern or an area enter event. Thus, when the master application receives such an event, the master application may start the relevant application. Then, the started application may set up the software module according to its needs and thereafter receive the desired events from the software module. The application will provide processing instructions to be performed in view of received events. When a new position is received which is not within the range that the running application is associated with, the master application may again check what application is associated with the new position and start the new relevant application. Thus, the master application may be used for switching between different applications that are to receive events from the software module depending on e.g. what positions are received from the pen. Further, the application may be initiated by the electronic pen and there is no need to start the application on the apparatus before the pen may be used.

According to an alternative, the application may be loaded to an electronic pen and be run on e.g. the control unit 410 of the electronic pen. Thereby the application may control a software module that is arranged to be run on the control unit 410 of the pen. The control of the software module may be performed in a similar way as described above with reference to FIG. 10. When the application is to run on the control unit 410 of the electronic pen, the pen may conveniently run a master application that is able to find and switch between the relevant applications to be run in relation to a received event. This may be detection of any position within the range of positions for which the application provides processing instructions. It may alternatively be detection of a specific start position. In such case, a user of the electronic pen may have a card with icons for starting different applications within the electronic pen. The card is also provided with a position-coding pattern such that when the pen is pointed on an icon, the pen will detect a start position of an application associated with the icon. The master application may typically be started when the pen is activated, e.g. by removing a cap or pressing a button.

Instead of running a master application that allows switching between different applications, the software module may comprise a list of applications associated with positions of the position-coding pattern. Thus, when the software module receives position data and no application is running, the software module may compare the position to the list of applications in order to start the relevant application. Further, when the running application receives position data of positions not associated with the application, the software module may again compare the new position with the list of applications for starting another application. The software module may have a registering function for allowing applications to be added to the list of applications in the software module.

Further, the software module may be set up in different ways by different applications. Thus, a first application may be run setting up the software module in its application-specific way. Thereafter, a second application may be run setting up the software module in another way, specific to the second application. Thus, the creating of event data by the software module may be dynamically controlled and customized to an application that is currently receiving input from the software module.

### 5. Interaction Module

Now, an example of a software module for refining pen data will be described in detail. This software module example will hereinafter be called “Interaction Module”. The Interaction Module is a software building block with an Application Programming Interface (API) that allows a system developer/deployer to integrate the module with customized software. Thus, through the Interaction Module API, an application created by the system developer/deployer may customize how basic events are to be refined by the Interaction Module. The system developer/deployer may thus design an application that controls the Interaction Module through the Interaction Module API so that the refining of pen data by the Interaction Module is properly set up.

The Interaction Module may advantageously use an electronic document in order to interpret pen input. As described above, the electronic document provides information of the layout of active areas in each document page. The Interaction Module may easily determine which document page that a recorded position belongs to by comparing the position to the pattern pages and layout mapping of the electronic document. Then, the layout of active areas of the relevant document page may be accessed and the position may be correlated to the layout of active areas. If the Interaction Module determines that the recorded position is within an active area, the Interaction Module may create an event signalling that the active area has been entered. Such an AreaEnter event may be used by an application program for handling the pen input by e.g. processing instructions associated with the active area.

In this way, the Interaction Module may be set up to quickly access the relevant layout of active areas and determine whether a recorded position is within an active area. Further, thanks to the format of the electronic document, the Interaction Module need only access the layout of the active areas of the relevant document page. Thus, the layout may be quickly read and only a small amount of memory is required.

The Interaction Module provides a stream of basic events that are created based on the pen data. Using the Interaction Module API, the application may set up objects that may filter events from the stream or generate new events to the stream. These objects are called EventHandlers. An EventHandler is a set of algorithms which is available within the Interaction Module and which may be activated by the application controlling the function of the Interaction Module. The EventHandler comprises predetermined function calls for setting up the EventHandler to filter events from the stream or generate new events to the stream. Thus, by initiating the EventHandler, a number of function calls become available to the application for generating the relevant event data. The application may create a link of several EventHandlers, such that an EventHandler may listen (or subscribe) to a stream of events from a previous EventHandler and filter and/or generate events before sending the stream of events further to a subsequent EventHandler. The possibility of setting up a link of EventHandlers provides a step-wise refinement of the basic events and facilitates creating an appropriate handling of pen input. In particular, an application controlling the function of the Interaction Module may advantageously set up a link of EventHandlers for controlling the Interaction Module to produce the desired event data. The application may listen to the stream of events from the last EventHandler for receiving the desired event data. Alternatively, the application may be arranged to receive event data from any EventHandler in the link, such that the application receives data of different refinement levels.

The Interaction Module may be used inside an electronic pen to provide real-time events to the pen control system, or it may be used in an external receiving apparatus to provide real-time events to an interactive application designed to give user feedback in real-time based on pen data. Such an application may thus provide essentially instant tactile, visual, audible, or audio-visual feedback to the user of the electronic pen based on the manipulation of the pen on the product surface.

The Interaction Module operates on pen data created by the control unit describing changes in the pen. In this regard, the Interaction Module is connected to receive the pen data from the control unit of the pen. In order for the event data to present information in a proper way to the application, the Interaction Module needs to be integrated to the form of pen data provided by the control unit of the pen. Thus, the Interaction Module is set up to ensure that position data is provided in a coordinate system that is used by the application that is to receive the position data. Thus, if required, the Interaction Module may convert the position data to the desired coordinate system. The position data received by the Interaction Module may be represented in the global coordinate system 12 and will then be converted to a page address and local position (in the local coordinate system 14′) of the pattern page 14 identified by the page address, or vice versa.

Each basic event created by the Interaction Module is also provided with a penID and a time stamp. When the Interaction Module is integrated in the pen, the penID may typically be fetched from persistent storage memory of the memory block 412 to be included in the basic event created by the Interaction Module. If the Interaction Module is arranged in an external receiving device, the pen is arranged to include the penID in a stream of pen data being transferred to the external receiving device. The control unit of the pen may provide the timestamp by means of its clock. However, the Interaction Module may need to convert a relative timestamp to an absolute timestamp.

The Interaction Module provides a specific API, the PenEvent API, for handling integration of the Interaction Module to the pen control system. The PenEvent API comprises functions such that the software developer/deployer may provide a penID and a time stamp to be included in events. Further, the software developer/deployer may use the appropriate function in the PenEvent API corresponding to the format of the position data. In this way, the Interaction Module may be set up to convert position data represented in the global coordinate system 12 to a page address and local position of the pattern page 14 identified by the page address.

### 5.1. Setting Up Handling of Pen Data

It will now be described in further detail how a system developer/deployer may use the Interaction Module to set up handling of pen data. The Interaction Module may be controlled by an application developed by the system developer/deployer such that the Interaction Module is set up when the application is started.

The Interaction Module comprises a basic EventHandler, called the BasicEventGenerator. The BasicEventGenerator receives pen data in the form specified by integration of the Interaction Module to the pen control system. The BasicEventGenerator exposes basic events of the pen data to any application or EventHandler that listens to the BasicEventGenerator. These events include PenConnected (indicating that the pen is connected to a remote apparatus and providing the penID of the connected pen), PenDisconnected (indicating disconnection of the pen); Error (indicating a data error in the stream of data), PenUp (indicating that the pen has been lifted from the product surface), Coord (including one item of position data), NewPageAddress (indicating that position data has been received from a new pattern page) and NoCode (indicating an inability to detect pattern).

The Interaction Module comprises an API, the EventLink API, for setting up how to further treat the basic events provided by the BasicEventGenerator. Using the EventLink API, an application may set up further EventHandlers that subscribe to the stream of events from the BasicEventGenerator. These EventHandlers may then filter the basic events to retain only the events relevant to the application. The EventHandlers may also generate more specific events. EventHandlers may be sequentially ordered in a link, such that a first EventHandler receives the stream of events from the BasicEventGenerator, while the second EventHandler receives events from the first EventHandler and the third EventHandler receives events from the second EventHandler and so on. This implies that the stream of events may be stepwise refined in order to extract the information needed regarding the pen input. Also, since the EventHandlers are linked, set-up of the handling of the stream of events is facilitated. Finally, the application may be set to receive events from the last EventHandler. Thus, a structure as shown in FIG. 11 may be set up in order to provide refining of pen data and provide relevant information to an application. The arrows indicate the direction of the stream of events progressing through the structure.

However, it should be noted that the EventHandlers may be connected to each other in more complex ways than just a linear sequence. For example, the rust EventHandler may be arranged to subscribe to events from the third EventHandler in the link, whereby the stream of events may be fed back into the link of EventHandlers. This may provide a feedback loop for the refinement of pen data. Further, the link of EventHandlers may comprise bifurcations, such that two different EventHandlers may listen to events from the same EventHandlers and process the event data in different ways. After processing through one or more EventHandlers of each bifurcation, a later EventHandler may receive event data from both bifurcations. Thus, the use of EventHandlers enables stepwise refinement of pen data through complex links of sets of algorithms of the Interaction Module.

The Interaction Module comprises yet another API, the InteractionEvents API. Using the InteractionEvents API, the application may access information from events produced by the EventHandlers such that the application may use the required information from the stream of events.

### 5.2. Example

### Handling Position in an Active Area

The Interaction Module will now be further described by providing an example of how to set up a response to drawing a stroke that enters an active area.

The Interaction Module provides several different functions within the EventLink API for creating specific EventHandlers. Information may be loaded to the EventHandlers such that the EventHandlers may use the information when receiving a stream of events. In this way, an EventHandler may create new events by comparing the stream of events to the loaded information.

Specifically, an EventHandler may be set up to generate events corresponding to recording position data in an active area. Such an EventHandler is hereinafter called AreaEventGenerator. First, an electronic document, preferably an AFD file, is loaded such that the AreaEventGenerator is able to access it. Since the AFD file is structured in several storage sections, it is possible for the AreaEventGenerator to access the specific parts of the AFD file that hold relevant information. In particular, the AreaEventGenerator may access an area collection from the AFD file, which may be used in order to determine whether a recorded position is within an active area. This may be set up by an application using the EventLink API.

The AreaEventGenerator may be set up to subscribe to the stream of events from the BasicEventGenerator. The BasicEventGenerator will thereby provide i.a. NewPageAddress and Coord events to the AreaEventGenerator. When the AreaEventGenerator receives a NewPageAddress event, the AreaEventGenerator will determine whether the new page address belongs to the loaded AFD file. In this regard, the new page address is compared to the .pattern file of the AFD file to determine whether the new page address is part of the pattern of the AFD file. If so, the page instance that corresponds to the new page address is determined. The AreaEventGenerator will thus load the .areas file providing the area collection of the relevant page instance. The AreaEventGenerator may also generate a PageEnter event, providing the page# and copy# of the page instance.

When an area collection has been loaded, the AreaEventGenerator will compare the local coordinate of each Coord event to the loaded area collection in order to determine whether the recorded position is within an active area. If the AreaEventGenerator finds that the position is within an active area, the AreaEventGenerator generates an AreaEnter event providing the areaID in the event data. When a Coord event is received that corresponds to a position outside the active area of the current areaID, the AreaEventGenerator generates an AreaExit event.

As shown above, the AreaEventGenerator may generate events providing information of entry into and exit from an active area. The AreaEventGenerator uses the electronic document in order to process recorded positions and identify these area events. Thanks to the format of the AFD file, the AreaEventGenerator may easily find the relevant area collections and the determination of AreaEnter and AreaExit events may thus be efficiently performed. According to an alternative, the AreaEventGenerator does not load the area collections, but instead uses a reference to the relevant portion of the AFD file.

The events from the AreaEventGenerator may be sent to an application for processing the events. The application may use the functions of the InteractionEvents API to retrieve event information, such as areaID of an active area that has been entered. Then, the application may trigger the processing instructions associated with the active area. The application may access the corresponding property collection of the AFD file in order to find an action to be performed in response to the electronic pen recording positions within the active area. Alternatively, the application may provide specific processing instructions to be performed at detection of entry into an active area.

Where the Interaction Module is integrated in the electronic pen, the application may be run on a processor in the electronic pen. The application may then, upon receiving an AreaEnter event, e.g. trigger the electronic pen to provide feed-back to the user through the MMI 420. For example, an indicator lamp may be lit, a message may be displayed, or the vibrator may be activated. Where the Interaction Module is run on an apparatus receiving pen data, an AreaEnter event may e.g. trigger received strokes to be stored in the AFD file, or trigger feed-back to be output by the apparatus, such as playing a video or audio file, or displaying a picture.

The Interaction Module may be arranged to generate other events to the stream of events in a similar way as described above for the AreaEventGenerator. Thus, other EventHandlers may be set up to, for example, generate events indicating a completed pen stroke.

The invention has mainly been described above with reference to a few embodiments. However, as is readily appreciated by a person skilled in the art, other embodiments than the ones disclosed above are equally possible within the scope and spirit of the invention, which is defined and limited only by the appended claims.

For example, since the pen data comprises a penID, an Interaction Module that is arranged in an apparatus receiving pen input may handle input from several pens simultaneously. Thus, several electronic pens may be connected to the same apparatus and transmit pen data to the apparatus without the pen data from the different pens being unintentionally mixed up.

It should be realized that it is not necessary to use an electronic file in the AFD file format. The Interaction Module does not necessarily need a file that stores different information separately. All information of the electronic file may be provided in one common file or alternatively, the electronic file loaded to the Interaction Module may merely provide information of layout of areas in a document page. It need for instance not include human-understandable graphics. Further, the layout of areas may be defined in global positions of the position-coding pattern.

Moreover, the positional information need not be provided as an optically readable position-coding pattern. Thus, the electronic pen may be arranged to record positional information in many different ways, e.g. detecting an electrical or chemical position-coding pattern or detecting a signal, e.g. an ultrasonic signal, from two or more transmitters such that the position of the pen may be determined through triangulation.

Further, it may be contemplated that the pen data is refined in two or more steps by two or more instances of the Interaction Module that possibly run on different apparatuses. For example, a first apparatus may be arranged to receive pen data from an electronic pen. A first application running on the first apparatus sets up a first Interaction Module to create AreaEvent data. The first application transmits the event data to a second apparatus. A second application running on the second apparatus sets up a second Interaction Module to refine the AreaEvent data received from the first apparatus. In this way, the second application may receive more processed AreaEvent information such as events relating to specific areas being entered, e.g. a login event that corresponds to a login area being entered. The processing of pen data in the first apparatus ensures that the amount of data sent between the first and second apparatus is minimized. Further, the first apparatus may be a simple device, e.g. a PDA, so that it may be desired that a major portion of the processing of pen data is performed on a second apparatus with more processing power.

Moreover, the layout mapping need not be restricted to a document page being associated with a single pattern page. The document page may be associated with portions of the position-coding pattern from different areas of the position-coding pattern. The Interaction Module may then be able to determine through the loaded electronic file the locations on a document page corresponding to the recorded positions. In this manner, the Interaction Module is able to reconstruct a stroke even if it contains a sequence of recorded positions from vastly different areas of the position-coding pattern. Also, an entry of positions in an active area may be detected by comparing the layout of active areas to the determined locations of strokes in the respective document page.

1. A system for creating a response to input by means of an electronic pen, said system comprising:
a processing unit in an electronic pen, which processing unit is arranged to receive positional information, which positional information is recorded when the electronic pen is used for writing on a printed document, said processing unit being further arranged to convert the positional information to a sequence of detected positions of said electronic pen in relation to the printed document;
a software module, which is arranged to receive pen data created by the processing unit during writing, said pen data including said sequence of detected positions, and which software module is arranged to refine said pen data by identifying pen data representing occurrences of specific events and create event data representing such specific events occurring; and
an application for providing processing instructions to be performed in response to input by means of the electronic pen, said application being arranged to load an electronic file to said software module, wherein said electronic file comprises information regarding said printed document, and to provide set-up instructions to said software module comprising setting up how the software module is to refine pen data, wherein said set-up instructions are application-specific and customizes the software module to the application and wherein the software module is set up by the set-up instructions to compare the pen data to information of the electronic file for identifying occurrences of events; said application being further arranged to receive event data from said software module and to process instructions that are related to event data representing an occurrence of a specific event.

2. The system according to claim 1, wherein the processing unit is arranged to receive positional information in the form of images of a position-coding pattern on the printed document.

3. The system according to claim 1, wherein the application is arranged to provide said set-up instructions to said software module upon starting of the application.

4. The system according to claim 1, wherein said application comprises a master application and subapplications and wherein said master application is arranged to associate subapplications with specific events, such that when event data representing an occurrence of such an event is received by the master application, the master application will start the associated subapplication and the subapplication will provide set-up instructions for setting up how the software module is to refine pen data.

5. The system according to claim 1, wherein said electronic file comprises a description of a layout of active areas on the printed document, and said application is arranged to provide set-up instructions for setting up the software module to compare the sequence of detected positions to the description of the layout of active areas for identifying pen data representing detected positions within an active area and create event data representing the electronic pen being used for writing in the active area.

6. The system according to claim 1, wherein said application is arranged to provide set-up instructions for setting up a link of event data handlers such that the software module creates event data in a plurality of steps, wherein event data is propagated through the link of event data handlers providing a stepwise refinement of pen data.

7. The system according to claim 1, wherein said software module comprises an Application Programming Interface for calling algorithms of the software module and said application is arranged to provide said set-up instructions by means of functions of said Application Programming Interface.

8. The system according to claim 1, wherein the software module is arranged to run on a processor of the electronic pen.

9. The system according to claim 1, wherein the software module is arranged to run on an external computing device which is arranged to receive pen data from the electronic pen.

10. The system according to claim 9, further comprising a plurality of electronic pens with processing units, wherein the software module is arranged to receive pen data from said plurality of electronic pens and create event data indicating an identification of the electronic pen causing the event data to be created.

11. A method of creating a response to input by means of an electronic pen, wherein said electronic pen comprises a processing unit, which is arranged to receive positional information, which positional information is recorded when the electronic pen is used for writing on a printed document, said processing unit being further arranged to convert the positional information to a sequence of detected positions of said electronic pen in relation to the printed document, said method being performed by an application providing processing instructions to be performed in response to input by means of the electronic pen, and said method comprising:
accessing a software module, which is arranged to receive pen data created by the processing unit during writing, said pen data including said sequence of detected positions, and which software module is arranged to refine said pen data by identifying pen data representing occurrences of specific events and create event data representing such specific events occurring;
loading an electronic file to said software module, wherein said electronic file comprises information regarding said printed document;
providing set-up instructions to said software module comprising setting up how the software module is to refine pen data, wherein said set-up instructions are application-specific and customizes the software module to the application and wherein the software module is set up by the set-up instructions to compare the pen data to information of the electronic file for identifying occurrences of events;
receiving event data from said software module; and
processing instructions that are related to event data representing an occurrence of a specific event.

12. The method according to claim 11, wherein the processing unit is arranged to receive positional information in the form of images of a position-coding pattern on the printed document.

13. The method according to claim 11, wherein said electronic file comprises a description of a layout of active areas on the printed document, and said providing of set-up instructions comprises setting up the software module to compare the sequence of detected positions to the description of the layout of active areas for identifying pen data representing detected positions within an active area and create event data representing the electronic pen being used for writing in the active area.

14. The method according to claim 11, wherein said loading and providing instructions are performed by the application for providing processing instruction in response to input by means of the electronic pen upon said application being started.

15. The method according to claim 14, further comprising registering said application to the software module in order for said application to receive said event data from the software module.

16. The method according to claim 11, wherein said application comprises a master application and subapplications and wherein said master application is arranged to associate subapplications with specific events, such that when event data representing an occurrence of such an event is received by the master application, the master application will start the associated subapplication and the subapplication will provide set-up instructions for setting up how the software module is to refine pen data.

17. The method according to claim 11, wherein said providing of set-up instructions comprises setting up a link of event data handlers such that the software module creates event data in a plurality of steps, wherein event data is propagated through the link of event data handlers providing a stepwise refinement of pen data.

18. The method according to claim 11, wherein said set-up instructions are provided as functions of an Application Programming Interface of the software module.

19. The method according to claim 11, wherein the software module is arranged to run on a processor of the electronic pen.

20. The method according to claim 11, wherein the software module is arranged to run on an external computing device which is arranged to receive pen data from the electronic pen.

21. The method according to claim 20, wherein the software module is arranged to receive pen data from a plurality of electronic pens and create event data indicating an identification of the electronic pen causing the event data to be created.

22. A computer-readable medium having recorded thereon computer-executable instructions for implementing the method as defined in claim 11.

23. A method of refining input by means of an electronic pen, wherein said electronic pen comprises a processing unit, which is arranged to receive positional information, which positional information is recorded when the electronic pen is used for writing on a printed document, said processing unit being further arranged to convert the positional information to a sequence of detected positions of said electronic pen, and wherein said refining comprises identifying pen data representing occurrences of specific events and creating event data representing such specific events occurring, said method comprising:
receiving pen data created by the processing unit during writing, said pen data including said sequence of detected positions;
receiving an electronic file, wherein said electronic file comprises information regarding said printed document, said electronic file being received from an application providing processing instructions to be performed in response to input by means of the electronic pen;
further receiving set-up instructions from the application, wherein said set-up instructions are application-specific; and
setting up refining of pen data in accordance with said received set-up instructions, whereby the refining is arranged to include comparing the pen data to information of the received electronic file for identifying occurrences of events.

24. The method according to claim 23, wherein said electronic file comprises a description of a layout of active areas on the printed document, and wherein said refining, as set up in accordance with said received set-up instructions, is arranged to include comparing the sequence of detected positions to the description of the layout of active areas for identifying pen data representing detected positions within an active area and creating event data representing the electronic pen being used for writing in the active area.

25. The method according to claim 23, wherein said setting up refining of pen data comprises setting up a link of event data handlers such that event data is created in a plurality of steps, wherein event data is propagated through the link of event data handlers providing a stepwise refinement of pen data.

26. A computer-readable medium having recorded thereon computer-executable instructions for implementing the method as defined in claim 23.

27. A software module for refining input by means of an electronic pen, wherein said electronic pen comprises a processing unit, which is arranged to receive positional information, which positional information is recorded when the electronic pen is used for writing on a printed document, said processing unit being further arranged to convert the positional information to a sequence of detected positions of said electronic pen in relation to the printed document, said software module being arranged to receive pen data created by the processing unit during writing, said pen data including said sequence of detected positions, and said software module being arranged to refine said pen data by identifying pen data representing occurrences of specific events and create event data representing such specific events occurring; said software module being configurable for refining pen data in different manners specific to different applications providing processing instructions to be performed in response to input by means of the electronic pen and said software module further comprising an application programming interface for accessing refining functions of the software module, said refining functions comprising:
allowing an electronic file to be loaded to said software module, wherein said electronic file comprises information regarding said printed document; and
allowing setting up how the software module is to refine pen data, including setting up the software module to compare the pen data to information of the electronic file for identifying occurrences of events.

28. The software module according to claim 27, wherein said electronic file comprises a description of a layout of active areas on the printed document, and said refining functions allowing setting up the software module to compare the sequence of detected positions to the description of the layout of active areas for identifying pen data representing detected positions within an active area and create event data representing the electronic pen being used for writing in the active area.

29. The software module according to claim 27, wherein said refining functions further comprises allowing setting up a link of event data handlers such that the software module creates event data in a plurality of steps, wherein event data is propagated through the link of event data handlers providing a stepwise refinement of pen data.
